(19) United States
(12) Patent Application Publication
(10) Pub. No.: US 2002/0112535 A1
(43) Pub. Date: Aug. 22, 2002

(54) Test bed for a thrust reverser

(76) Inventors: Gerard Guillet, Vivegnis (BE); Pierre-Manuel Jacob, Huy (BE)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/025,837

(22) Filed: Dec. 18, 2001

(30) Foreign Application Priority Data
Dec. 18, 2000 (EP) 00 870 305.0

(51) Int. Cl. G01L 3/26

(52) U.S. Cl. 73/116

(57) ABSTRACT

The present invention relates to a test bed intended to test the functioning of a thrust reverser of an engine, preferably a turbojet engine equipped with the thrust reverser. The engine is able to draw in and expel air in a certain direction in a primary flow, and the thrust reverser is able to circulate the gases derived from the combustion between the air and at least one fuel in a secondary flow, directed in a direction substantially opposite to that of the primary flow. The bed is provided with means for collecting and recovering the gases derived from the thrust reverser, and which are able to redirect the gases exiting this thrust reverser in the direction of the primary flow. The collector means comprise at least one deflector and two half-shells, preferably made of metal, facing each other and open at least on one external face. The present invention also relates to a device for collecting and redirecting the gas flow extracted from a thrust reverser, and to its uses.

### CROSS-REFERENCE TO RELATED APPLICATIONS

This application claims priority to European Application Serial Number 00 870 305.0, filed Dec. 18, 2000, the disclosure of which is herein incorporated by reference in its entirety.

### BACKGROUND OF THE INVENTION

1. Field of the Invention

The field of application concerned by the present invention is that of aviation and aeronautics.

The present invention relates to a device for testing the correct functioning of a thrust reverser present on an engine of turbojet engine type, said test being performed on an internal or external ground test bed.

2. Description of the Related Art

Up to the start of the 1940s, the conventional mode of propulsion for civil or military aircraft was the piston engine which drove one or more propellers and allowed the aircraft to move forward by the rotation of (a) propeller(s) expelling the air towards the rear of the aircraft. There then appeared the first turbojet engines, known as “straight-flow turbojet engines” which use another mode of propulsion: jet propulsion.

A straight-flow turbojet engine consists of a streamlined casing that draws in and compresses air from the outside. A combustion reaction takes place in a combustion chamber between the heated air and the fuel. The burnt gases pass into a turbine, to which they give some of their energy, which will be used for the compressor stage. Next, the burnt gases are ejected towards the rear, where they depressurize at high speed in a nozzle, exerting on the walls of this nozzle a thrust, which gives the aircraft jet propulsion.

Some civil or military aircraft nowadays use as a means of propulsion a turbofan engine, also known as a “turbojet bypass engine”. Aircraft equipped in this way are less noisy and consume less energy than aircraft equipped with straight-flow turbojet engines. In reactors of this type, some of the air taken in is not heated, and undergoes only a small compression before being directly expelled in the nozzle.

In order for them to be able to brake, civil jet aircraft are equipped with a special device mounted on the turbojet engine and known as a “thrust reverser”. The thrust reverser is a device which is in the form of a deflector which allows some or all of the gases to be diverted in the direction opposite to the thrust, i.e. towards the front of the jet engine, and thus to obtain, as its name indicates, a reversal of the thrust.

Two main types of thrust reverser exist: clamshell reversers and reversers with doors or shutters. Clamshell reversers consist of half-shells which are placed directly in the gas flow, and in particular in the air flow, and divert the flow laterally. As regards reversers with doors or shutters, these are mainly used to divert the cold flow of the turbofan engines. Examples of thrust reversers are given in documents European Patent No. 0 043 764, European Patent No. 0 067 747, French Application No. 2 559 838 and European Patent No. 0 310 497.

It is essential to be able to test the correct functioning of these thrust reversers in order to check their mechanical and aerodynamic characteristics and behavior. The reason for this is that these thrust reversers are a critical component of the aircraft, and their dysfunction in flight has already been the cause of several crashes. The problem is that the tests currently performed on the functioning of thrust reversers do themselves present risks, insofar as they must be carried out either in flight or on the ground in external test beds. Internal ground test beds generally used for testing the other components of the aircraft cannot in fact be used in this particular case, since the circulation of the gas flow imposed by the test bed and that of the thrust reverser act in opposite directions, which would lead to degradation both of the components of the bed and of the thrust reverser, and also a reinjection of burnt gases by the engine being tested, which may cause this engine to stall and risk damaging it.

Document of Mehalic C M & Lotting R A entitled “Full-scale thrust-reverser testing in an altitude facility”, AIAA Paper, no. 87-1788, 1987, pages 1-13, XP001004710, discloses a reverser collecting system for testing a thrust reverser, said reverser collecting system being able to capture the reverser exhaust and to transport it to the primary exhaust collector. It is specified that said collecting system consist of two rectangular cross section ducts of stainless steel comprising turning vanes, support hardware for the ducts and a conical adapter section to the primary exhaust collector.

Document French Application No. 2 671 179 discloses a ground testing installation for an aircraft jet engine having a nozzle that is steerable relative to the longitudinal axis of said engine, said installation comprising a silencer arranged behind the nozzle and a funneling device arranged between the engine and the silencer. Said funneling device is intended for funneling the jet of exhaust gases from the engine and comprises an outer shell and an inner shell, both cylindrical and concentric. The relative configuration of said outer and inner shells is such that they form a channel adapted to enable cooling airflow therealong. The outer shell has a flared-end portion at the vicinity of the engine which may be adapted particularly for testing the engine in thrust reversal and have a double envelope or one or more coils for circulation of cooling airflow therein.

However, at the current time, no solution that would allow this problem of testing thrust reversers to be solved has yet been proposed.

### SUMMARY OF THE INVENTION

The present invention aims to solve this problem of the ground testing of thrust reversers in an internal test bed or an external test bed.

More precisely, the present invention aims to provide a solution that is simple to use and of moderate cost.

The present invention aims also to provide a solution that is reliable and that offers maximum safety.

The present invention aims also to provide a solution that can also be used in the case of a test without a thrust reverser.

The present invention relates to a test bed intended to test the functioning of a thrust reverser of an engine, preferably a turbojet engine equipped with said thrust reverser. The engine is able to draw in and expel air in a certain direction in a primary flow, and the thrust reverser is able to circulate the gases derived from the combustion between the air and at least one fuel in a secondary flow, directed in a direction essentially opposite to that of the primary flow. The bed is characterized in that it is provided with means for collecting and recovering the gases derived from the thrust reverser. The means is capable of redirecting the gases exiting this thrust reverser in the direction of said primary flow.

Preferably, the gas collecting and recovery means, which are able to redirect the gases exiting the thrust reverser in the direction of the primary flow, comprise at least one deflector and two half-shells, preferably made of metal, facing each other and open at least on one external face.

Preferably, each half-shell is divided into compartments separated by walls that are substantially parallel so as to allow a laminar flow of the gas flow.

Preferably, the gas collecting and recovery means are also provided with means for attachment to the thrust reverser and/or to the engine.

The present invention also relates to a device comprising at least one deflector and two half-shells, facing each other and open at least on one external face, each of these half-shells being divided into compartments separated by walls that are substantially parallel.

Preferably, the half-shells are made of metal.

Preferably, the device is also provided with attachment means.

The present invention also relates to the use of this device for collecting and redirecting the flow extracted from a thrust reverser, the direction of said gas flow entering and exiting said device being substantially opposite.

Another subject of the present invention is the use of this device on an internal test bed for the ground testing of the functioning of a thrust reverser.

Finally, the present invention also relates to the use of this device on an external test bed for the ground testing of the functioning of a thrust reverser.

### BRIEF DESCRIPTION OF THE DRAWINGS

FIG. 1 is a view showing the positioning of the flow collector at the outlet of the thrust reverser of a turbojet engine in the internal test bed according to the invention.

### DETAILED DESCRIPTION OF THE PREFERRED EMBODIMENT

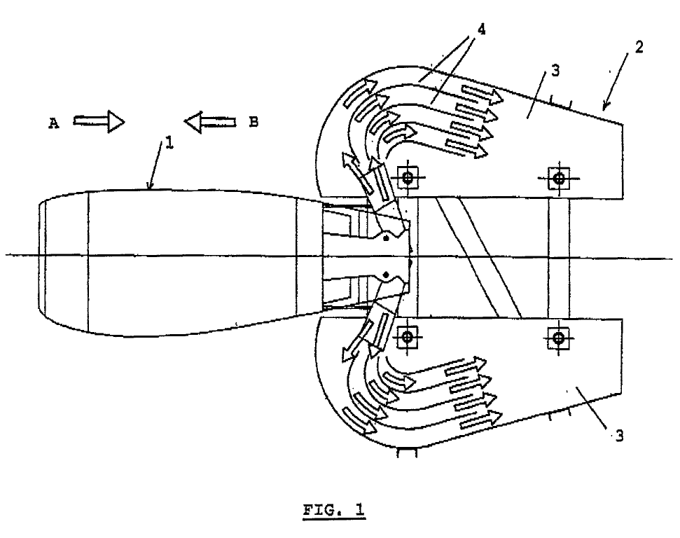

FIG. 1 illustrates an example of a thrust reverser to be tested in an internal test bed according to the present invention. Since the turbojet engine is able to draw in and expel air in a certain direction in a primary flow represented schematically by the arrow A, this thrust reverser 1 to be tested is able to circulate the burnt gases, derived from the combustion between the air and at least one fuel, in a secondary flow directed in a direction essentially opposite to that of said primary flow and represented schematically by the arrow B. At the outlet of the thrust reverser are arranged means 2 for collecting and recovering the air derived from the thrust reverser. These means 2 comprise two half-shells 3 that are, for example, made of metal, arranged facing each other and open on one face. These half-shells 3 are provided with at least one deflector 4. The air derived from the thrust reverser is thus recovered inside the half-shells 3 and redirected in the direction of said primary flow, as shown by the arrows C. Each half-shell 3 is divided into compartments separated from each other by walls that are substantially parallel so as to allow a laminar flow of the gas flow. In addition, the deflectors 4 positioned inside the half-shells 3 allow a rational distribution of the airstream in the collecting means 2.

What is claimed is:

1. A test bed for testing a thrust reverser of an engine comprising:
an engine, wherein said engine draws in and expels air in a direction in a primary flow;
a thrust reverser, wherein said thrust reverser circulates the gases derived from the combustion between the air and at least one fuel in a secondary flow, directed in a direction substantially opposite that of said primary flow; and
a collecting and recovering component, said component redirecting the gases exiting said thrust reverser in the direction of said primary flow,
wherein said collecting and recovering component comprises at least one deflector and two half-shells facing each other and open at least on one external face.

2. The test bed of claim 1, wherein said engine is a turbojet engine.

3. The test bed of claim 1, wherein said collecting and recovering component comprises a metal.

4. The test bed of claim 1, wherein each half-shell is divided into compartments separated by walls that are substantially parallel to allow a laminar flow of the gas flow.

5. The test bed of claim 1, wherein said collecting and recovering component comprises an attachment component for attaching said component to said thrust reverser.

6. The test bed of claim 1, wherein said collecting and recovering component comprises an attachment component for attaching said component to said engine.

7. The test bed of claim 1, wherein said collecting and recovering component comprises an attachment component for attaching said collecting and recovering component to said thrust reverser and to said engine.

8. The test bed of claim 1, wherein said test bed is internal.

9. The test bed of claim 1, wherein said test bed is external.

10. A device comprising:
at least one deflector; and
two half-shells, facing each other and open at least on one external face,
wherein said half-shells are divided into compartments separated by walls that are substantially parallel.

11. The device of claim 10, further comprising an attachment component for attaching said device to a thrust reverser, to an engine or to both a thrust reverser and an engine.

12. The device of claim 10, wherein said half-shells comprise metal.

13. A method of testing a thrust reverser of an engine on a test bed, comprising:
obtaining a device comprising at least one deflector and two half-shells, facing each other and open at least on one external face, wherein said half-shells are divided into compartments separated by walls that are substantially parallel; and
attaching said device to a thrust reverser in a test bed such that the flow of gases entering and exiting said device are substantially opposite.

14. The method of claim 13, wherein said test bed is an internal test bed.

15. The method of claim 13, wherein said test bed is an external test bed.
